(19) United States
(12) Patent Application Publication
(10) Pub. No.: US 2011/0220152 A1
(43) Pub. Date: Sep. 15, 2011

(54) SUPERCRITICAL DRYING METHOD AND SUPERCRITICAL DRYING APPARATUS

(76) Inventors: Yukiko KITAJIMA, Ishikawa (JP); Hisashi Okuchi, Kanagawa (JP); Hiroshi Tomita, Kanagawa (JP); Hidekazu Hayashi, Kanagawa (JP); Tatsuhiko Koide, Mie (JP)

(21) Appl. No.: 12/963,952

(22) Filed: Dec. 9, 2010

(30) Foreign Application Priority Data
Mar. 15, 2010 (JP) 2010-058281

(51) Int. Cl. B08B 3/00; F26B 21/00

(52) U.S. Cl. 134/26; 34/72

(57) ABSTRACT

According to one embodiment, a substrate having a plurality of adjacent patterns on one surface thereof is cleaned by cleaning liquid. Subsequently, after the cleaning liquid is displaced with pure water, the pure water is displaced with displacement liquid. Under a condition that the displacement liquid among the patterns does not vaporize, the displacement liquid not contributing to prevention of collapse of the patterns is removed. After the displacement liquid is removed, the substrate is held in supercritical fluid and the displacement liquid among the patterns is displaced with the supercritical fluid. After the displacement liquid among the patterns is displaced with the supercritical fluid, the supercritical fluid adhering to the substrate is vaporized.

### CROSS-REFERENCE TO RELATED APPLICATIONS

This application is based upon and claims the benefit of priority from Japanese Patent Application No. 2010-058281, filed on Mar. 15, 2010; the entire contents of which are incorporated herein by reference.

### FIELD

Embodiments described herein relate generally to a supercritical drying method and a supercritical drying apparatus.

### BACKGROUND

In recent years, according to the advance of microminiaturization of semiconductor devices, aspect ratios of patterns are high. Therefore, in manufacturing of the semiconductor devices, there is a problem of a phenomenon in which patterns are joined after undergoing cleaning and drying processes for a substrate by liquid (pattern collapse). Concerning such a problem, it is known that, if a supercritical drying technology is used for the drying process, the pattern collapse phenomenon due to surface tension during drying can be suppressed by drying the substrate using an ideal medium having no surface tension. For example, Japanese Patent Application Laid-Open No. 2006-332215 discloses that supercritical drying by supercritical carbon dioxide (CO₂) is performed under high pressure (supercritical pressure equal to or higher than about 8 megapascals).

When the substrate is held under a supercritical carbon dioxide state in a chamber, a displacement solvent such as IPA is discharged (dissolved) in the supercritical carbon dioxide from the surface of the substrate and spaces among patterns. The displacement solvent remaining among the patterns is displaced with the supercritical carbon dioxide. After the spaces among the patterns are completely filled with the supercritical carbon dioxide, the supercritical carbon dioxide is vaporized and discharged. After the pressure in the chamber is reset to the atmospheric pressure, the substrate is unloaded. Consequently, drying of the patterns is completed.

### BRIEF DESCRIPTION OF THE DRAWINGS

FIG. 1 is a schematic diagram of the configuration of a supercritical drying apparatus according to a first embodiment;

FIG. 2 is a flowchart for explaining an example of a supercritical drying method according to the first embodiment;

FIGS. 3A to 3G are schematic diagrams for explaining the example of the supercritical drying method according to the first embodiment;

FIGS. 4A to 4C are schematic diagrams for explaining a method of discharging excess IPA on a substrate in the supercritical drying method according to the first embodiment;

FIGS. 5A and 5B are schematic diagrams for explaining processing for detecting the completion of the discharge of the IPA using a fluid flow meter in the supercritical drying method according to the first embodiment;

FIGS. 6A and 6B are schematic diagrams for explaining processing for detecting the completion of the discharge of the IPA using a gas densitometer in the supercritical drying method according to the first embodiment;

FIG. 7 is a flowchart for explaining another example of the supercritical drying method according to the first embodiment;

FIGS. 8A and 8B are schematic diagrams for explaining drying of the rear surface of the substrate by nitrogen gas blow in the supercritical drying method according to the first embodiment;

FIG. 9 is a schematic diagram for explaining drying of the rear surface of the substrate by an air cutter in the supercritical drying method according to the first embodiment;

FIG. 10 is a diagram of a state of carbon oxide;

FIG. 11 is a characteristic chart of a relation of solubility parameters between IPA and CO₂;

FIG. 12 is a flowchart for explaining an example of a supercritical drying method according to a second embodiment; and

FIGS. 13A to 13G are schematic diagrams for explaining the example of the supercritical drying method according to the second embodiment.

### DETAILED DESCRIPTION

In general, according to one embodiment, a substrate having a plurality of adjacent patterns on one surface thereof is cleaned by cleaning liquid. Subsequently, after the cleaning liquid is displaced with pure water and after the pure water is displaced with supercritical pure water, the supercritical pure water is displaced with displacement liquid. Under a condition that the displacement liquid among the patterns does not vaporize, the displacement liquid not contributing to prevention of collapse of the patterns is removed. After the displacement liquid is removed, the substrate is held in supercritical fluid and the displacement liquid among the patterns is displaced with the supercritical fluid. After the displacement liquid among the patterns is displaced with the supercritical fluid, the supercritical fluid adhering to the substrate is vaporized.

Exemplary embodiments of a supercritical drying method and a supercritical drying apparatus will be explained below in detail with reference to the accompanying drawings. The present invention is not limited to the following embodiments. The embodiments can be changed as appropriate without departing from the spirit of the present invention. In the drawings referred to below, for facilitation of understanding, in some case, scales of members are different from actual scales. The same holds true among the drawings.

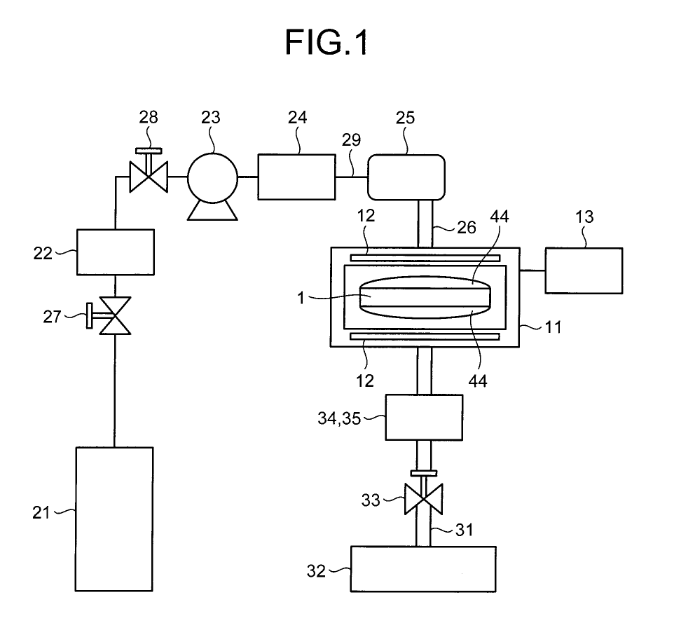

FIG. 1 is a schematic diagram of the configuration of a supercritical drying apparatus according to a first embodiment. In the supercritical drying apparatus according to this embodiment, as shown in FIG. 1, a substrate 1 as a processing target is fixed by a not-shown holding mechanism in a chamber for supercritical drying processing 11, which is a closable supercritical drying processing chamber in which supercritical drying is performed, and the supercritical drying processing is performed. A plurality of adjacent fine patterns are formed on a principal plane of the substrate 1. The chamber for supercritical drying processing 11 as the supercritical drying processing chamber is a pressure resistance chamber that is made of a material such as SUS316 and can withstand pressure of 0 to 20 megapascals.

A liquefied carbon dioxide cylinder 21 that stores liquefied carbon dioxide is connected to a gas inflow side in the chamber of supercritical drying processing 11 via a cooler 22, a pump unit 23, a vaporizer 24, a filter 25, and a gas inlet pipe 26. The liquefied carbon dioxide pressurized to, for example, several megapascals is stored in the liquefied carbon dioxide cylinder 21. Control valves 27 and 28 for flow rate adjustment are respectively provided between the liquefied carbon dioxide cylinder 21 and the cooler 22 and between the cooler 22 and the pump unit 23. The members are connected by a pipe 29. A carbon-dioxide-gas supplying unit that supplies carbon dioxide gas (CO₂ gas) as inert gas into the chamber for supercritical drying processing 11 is configured by these members.

A discharging device 32 is connected to a gas discharge side in the chamber for supercritical drying processing 11 via a gas discharge pipe 31. A control valve 33 for flow rate adjustment is provided in the gas discharge pipe 31. A gas discharging unit that discharges gas in the chamber for supercritical drying processing 11 is configured by these members. A fluid flow meter 34 and a gas densitometer 35 are connected to the gas discharge pipe 31 as a discharge-state detecting unit for detecting, for example, presence or absence of liquid in the gas discharged from the chamber for supercritical drying processing 11 by the gas discharging unit to thereby sense a discharge state of excess IPA 44 on the substrate 1 and detect the completion of the discharge of the excess IPA 44 on the substrate 1. A recycling mechanism (not shown) for collecting, separating, and reusing carbon dioxide gas and IPA is connected to the discharging device 32. Besides the fluid flow meter and the gas densitometer, a capacitance sensor can be used.

A pressure control unit that can control to pressurize the pressure in the chamber for supercritical drying processing 11 to pressure in a supercritical state of carbon dioxide gas is configured by the pump unit 23, the vaporizer 24, the discharging device 32, and the valve 33.

The chamber for supercritical drying processing 11 includes a heating plate 12 and an intra-processing chamber temperature sensor 13 that measures the temperature in the chamber for supercritical drying processing 11 as a temperature control unit that can control the temperature of the substrate 1 to predetermined temperature and control the temperature in the chamber for supercritical drying processing 11 to temperature of the supercritical state of carbon dioxide gas (supercritical carbon dioxide). The pressure control unit and the temperature control unit are controlled to predetermined conditions manually or by a not-shown control unit.

Pattern collapse is a phenomenon in which force contributing to collapse is given to a pattern side when a solvent remaining on a substrate surface dries among patterns. A solvent contributing to prevention of pattern collapse in this embodiment indicates a solvent present in spaces among the patterns equal to or lower than the height of the upper surface of the patterns. In the prevention of pattern collapse, it is important that the solvent is present in the spaces. Therefore, to suppress the pattern collapse, the spaces among the patterns before being subjected to supercritical drying need to be always filled with some solvent. For example, for a substrate after wet etching treatment, first, rinse treatment is performed by using pure water as rinse liquid (a displacement solvent), etching liquid is displaced with the pure water, and the pure water is displaced with another kind of rinse liquid (another displacement solvent). To dry the substrate using supercritical carbon dioxide (CO₂), alcohol (isopropyl alcohol (IPA), etc.) that is dissolved (easily displaces) both the pure water and the supercritical CO₂ is used as the rinse liquid (the displacement solvent).

To completely dry the displacement solvent adhering to the substrate in the supercritical drying by the supercritical carbon dioxide, it is necessary to surely discharge the displacement solvent dissolved in the supercritical carbon dioxide from the chamber. However, when an amount of the displacement solvent dissolved in the supercritical carbon dioxide increases, it takes long to purge out the displacement solvent dissolved in the supercritical carbon dioxide in the chamber from the chamber and drying processing time is extended. Therefore, it is desirable to reduce the displacement solvent dissolved in the supercritical carbon dioxide as much as possible.

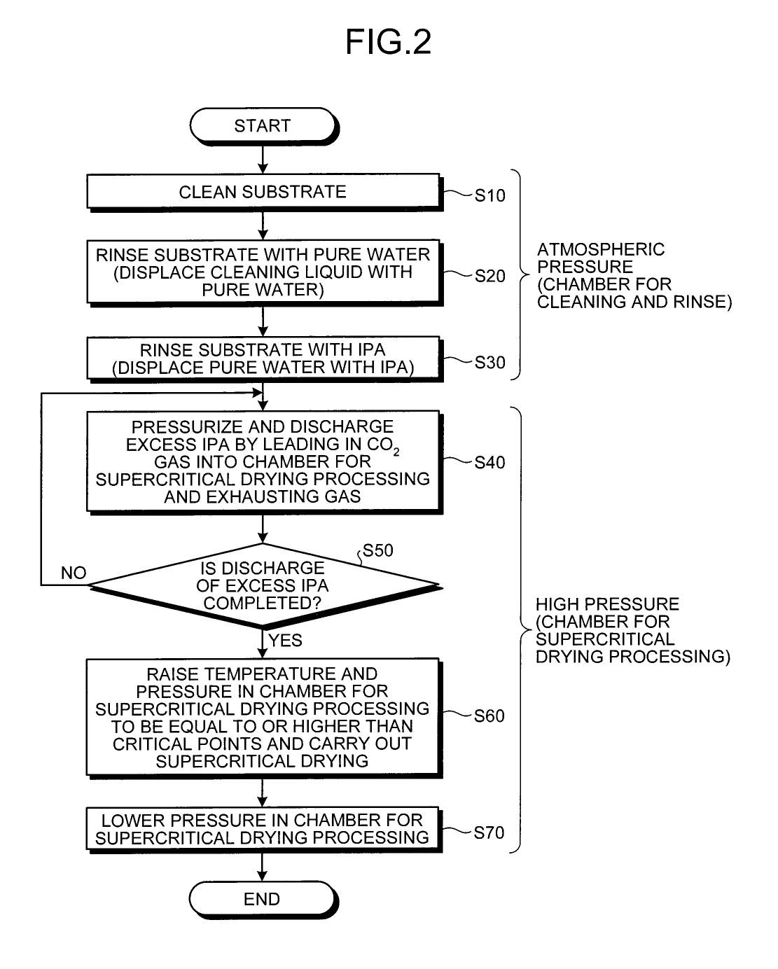

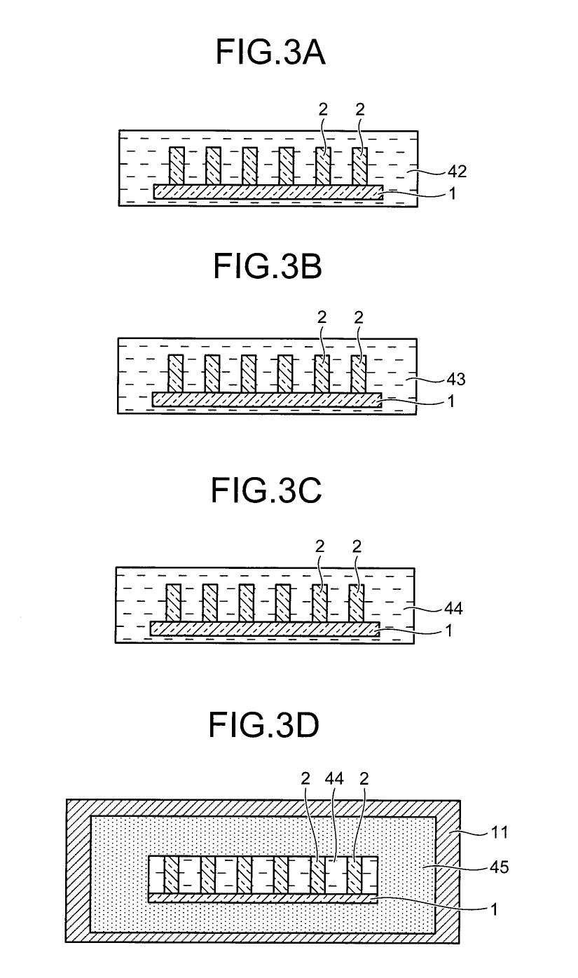

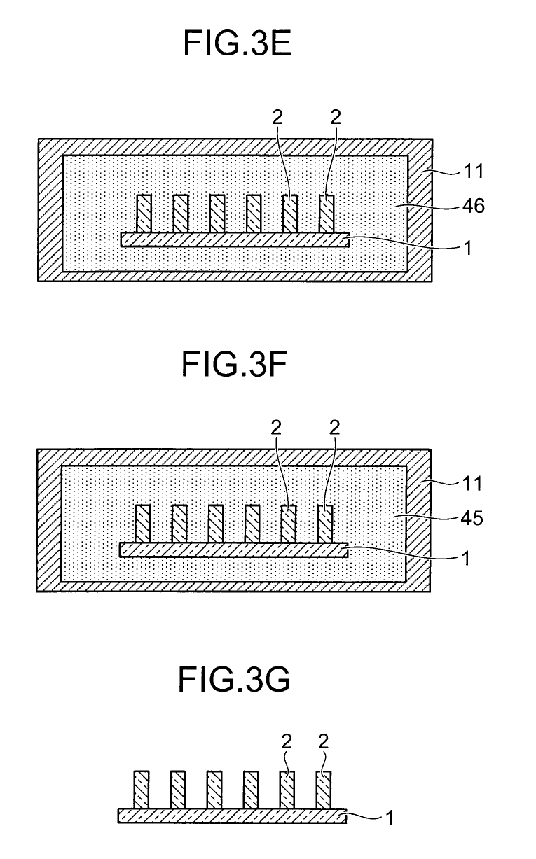

A supercritical drying method by the supercritical drying apparatus according to the first embodiment configured as explained above is explained below with reference to FIG. 2 and FIGS. 3A to 3G. FIG. 2 is a flowchart for explaining an example of the supercritical drying method according to the first embodiment. FIGS. 3A to 3G are schematic diagrams for explaining the example of the supercritical drying method according to the first embodiment.

First, as the substrate 1, a semiconductor substrate having a plurality of adjacent fine patterns 2 formed on a principal surface thereof by a publicly-known technology is prepared. The supercritical drying apparatus loads the substrate 1 into a not-shown chamber for cleaning and rinse (a first chamber) as a cleaning and rinse treatment chamber. In this embodiment, line and space patterns are explained as an example of fine patterns. The supercritical drying apparatus supplies cleaning liquid (etching liquid) 42 such as acid or alkali onto the substrate 1 in the chamber for cleaning and rinse and cleaning treatment for the substrate 1 is performed (step S10 in FIG. 3A).

After the cleaning treatment, the supercritical drying apparatus supplies pure water 43 as first displacement liquid onto the substrate 1 in the chamber for cleaning and rinse, performs rinse treatment (displacement treatment) by the pure water 43, and displaces the cleaning liquid 42 adhering to the substrate 1 with the pure water 43 (step S20 in FIG. 3B). After the rinse treatment, the supercritical drying apparatus supplies IPA 44 as second displacement liquid onto the substrate 1 in the chamber for cleaning and rinse, performs rinse treatment (displacement treatment) by the IPA 44, and displaces the pure water 43 adhering to the substrate 1 with the IPA 44 (step S30 in FIG. 3C). The treatment at steps S10, S20, and S30 is performed under the atmospheric pressure in the chamber for cleaning and rinse. Steps S10, S20, and S30 can be performed by a batch-type apparatus that collectively processes a plurality of the substrates 1 or can be performed by a single-wafer apparatus that processes and spin-dries the substrates 1 one by one.

Subsequently, the supercritical drying apparatus discharges the excess IPA 44 from the chamber for cleaning and rinse and removes the substrate 1 and conveys the substrate 1 to a chamber for supercritical drying processing (a second chamber) 11 as a supercritical drying processing chamber while the surface of the substrate 1 does not dry. Specifically, the supercritical drying apparatus conveys the substrate 1 to the chamber for supercritical drying processing 11 in a state in which the fine patterns 2 are covered by the IPA 44 on the surface on which the fine patterns 2 are formed (hereinafter, “pattern forming surface”) and the IPA 44 is present among the adjacent fine patterns 2. The IPA 44 is present on the pattern forming surface of the substrate 1 in this state by an amount equal to or larger than an amount necessary for preventing collapse of the fine patterns 2 by capillary force among the fine patterns 2 due to the drying of the IPA 44.

The supercritical drying apparatus closes the chamber for supercritical drying processing 11 and supplies carbon dioxide gas into the chamber for supercritical drying processing 11 with the carbon-dioxide-gas supplying unit. The liquefied carbon dioxide stored in the liquefied carbon dioxide cylinder 21 is cooled to predetermined temperature by the cooler 22, pressurized to predetermined pressure by the pump unit 23, and vaporized by the vaporizer 24. Thereafter, the liquefied carbon dioxide is led into the chamber for supercritical drying processing 11 from the gas inlet pipe 26 via the filter 25.

The supercritical drying apparatus expels the excess IPA 44 in the chamber for supercritical drying processing 11 by opening the gas discharging unit while supplying carbon dioxide gas 45 into the chamber for supercritical drying processing 11 with the carbon-dioxide-gas supplying unit. Consequently, the excess IPA 44 present on the pattern forming surface of the substrate 1 is pressurized and discharged in a liquid state from the chamber for supercritical drying processing 11 by the carbon dioxide gas 45 (step S40 in FIG. 3D). This pressurization and discharge is referred to as high-pressure drain. This makes it possible to reduce an amount of the IPA 44 held on the substrate 1 before the supercritical drying processing. Besides the IPA 44 contributing collapse present among the patterns of the substrate 1, the IPA 44 adhering to the inner wall of the chamber for supercritical drying processing 11, for example, during conveyance of the substrate 1 can also be removed.

The carbon dioxide gas 45 in the chamber for supercritical drying processing 11 is set in a condition that the IPA 44 does not vaporize and keeps the liquid state and in a state in which temperature is equal to or higher than 31.1° C. and pressure is lower than 7.4 megapascals. This state of the carbon dioxide gas can be controlled by adjusting conditions in the units of the carbon-dioxide-gas supplying unit and the gas discharging unit.

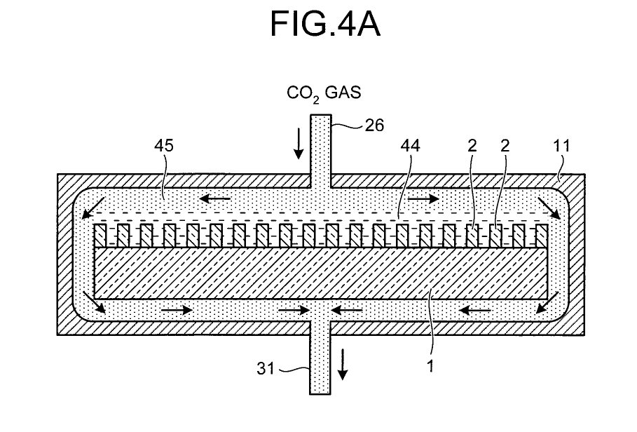

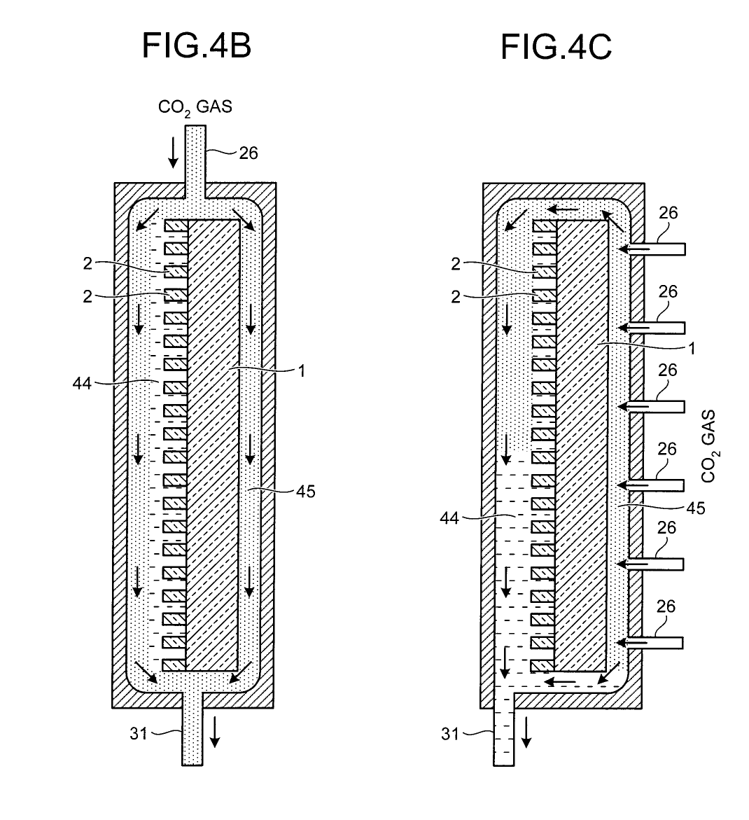

FIGS. 4A to 4C are schematic diagrams for explaining a method of discharging (removing) the excess IPA 44 on the substrate 1 in the supercritical drying method according to the first embodiment. The pressurization and the discharge of the excess IPA 44 on the substrate 1 are performed by, for example, in a state in which the substrate 1 is held horizontally in the chamber for supercritical drying processing 11 to face the pattern forming surface upward as shown in FIG. 4A, supplying the carbon dioxide gas 45 into the chamber for supercritical drying processing 11 from an upper part of the substrate 1 and discharging the carbon dioxide gas 45 from a lower part or a side of the substrate 1. This makes it possible to pressurize and discharge, in the liquid state, the excess IPA 44 present on the pattern forming surface of the substrate 1 by the carbon dioxide gas 45.

FIGS. 4B and 4C are schematic diagrams for explaining another method for pressurizing and discharging the excess IPA 44 on the substrate 1. The pressurization and the discharge of the excess IPA 44 on the substrate 1 can also be performed by, for example, in a state in which the substrate 1 is held vertically in the chamber for supercritical drying processing 11 as shown in FIG. 4B, supplying the carbon dioxide gas 45 into the chamber for supercritical drying processing 11 from the upper part of the substrate 1 and discharging the carbon dioxide gas 45 from the lower part of the substrate 1. In this case, because the carbon dioxide gas 45 flows from the side to the rear side (the opposite side of the pattern forming surface) of the substrate 1, it is possible to pressurize and discharge, in the liquid state, the excess IPA 44 adhering to the rear side of the substrate 1 with the carbon dioxide gas 45 besides the excess IPA 44 present on the pattern forming surface of the substrate 1. Therefore, it is possible to dry the rear side of the substrate 1 and further reduce an amount of the excess IPA 44 held on the substrate 1.

The pressurization and the discharge of the excess IPA 44 on the substrate 1 can also be performed by, for example, in a state in which the substrate 1 is held vertically in the chamber for supercritical drying processing 11 as shown in FIG. 4C, leading the carbon dioxide gas 45 into the chamber for supercritical drying processing 11 from the rear side of the chamber for supercritical drying processing 11 and discharging the carbon dioxide gas 45 from the lower part of the chamber for supercritical drying processing 11. In this case, because the carbon dioxide gas 45 flows into the chamber for supercritical drying processing 11 after being supplied to the rear surface of the substrate 1, it is possible to pressurize and discharge, in the liquid state, the excess IPA 44 adhering to the rear side of the substrate 1 with the carbon dioxide gas 45 besides the excess IPA 44 present on the pattern forming surface of the substrate 1. Therefore, it is possible to dry the rear side of the substrate 1 and further reduce an amount of the excess IPA 44 held on the substrate 1. Gas supplied to the rear surface of the substrate 1 is desirably regarded as only heated carbon dioxide gas. Heated inert gas such as nitrogen gas can also be supplied to the rear surface of the substrate 1 before or after the carbon dioxide gas 45 is led into the chamber for supercritical drying processing 11. The air (high-purity air) can be used instead of the inert gas.

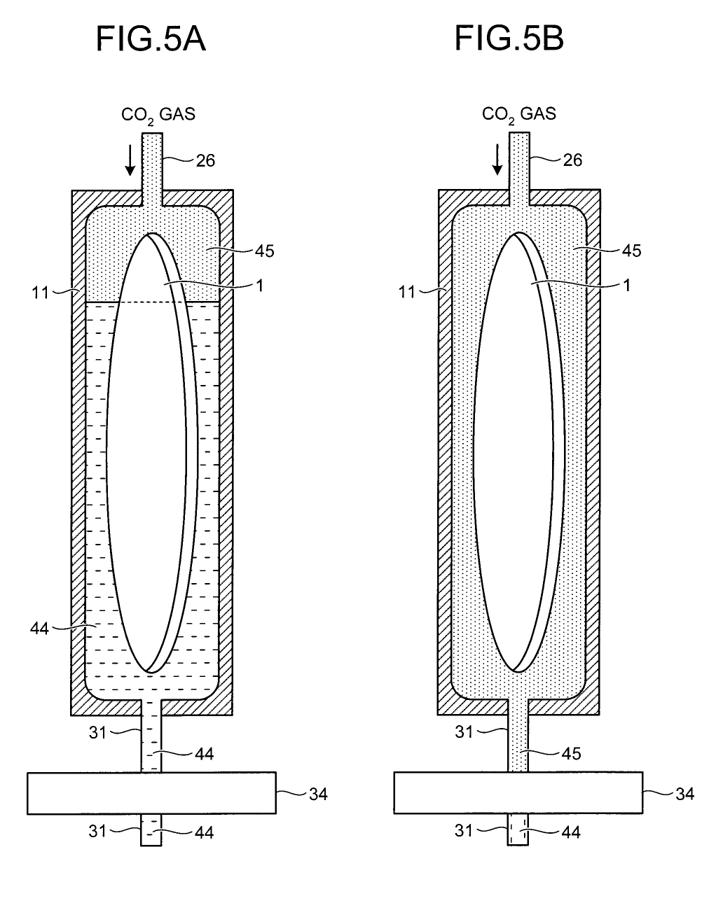

Subsequently, the supercritical drying apparatus detects, using the fluid flow meter 34 and the gas densitometer 35, whether the discharge of the excess IPA 44 on the substrate 1 is completed (step S50). FIGS. 5A and 5B are schematic diagrams for explaining processing for detecting the completion of the discharge of the IPA 44 using the fluid flow meter 34. The start of the processing for discharging the excess IPA 44 on the substrate 1 is shown in FIG. 5A. The completion of the processing for discharging the excess IPA 44 on the substrate 1 is shown in FIG. 5B. At the start of the processing for discharging the IPA 44 on the substrate 1, because the IPA 44 is included in gas discharged from the chamber for supercritical drying processing 11 via the gas discharge pipe 31 as shown in FIG. 5A, liquid is detected by the fluid flow meter 34 provided halfway in the gas discharge pipe 31.

On the other hand, when the discharge of the excess IPA 44 is completed, because the IPA 44 is not included in the gas discharged from the chamber for supercritical drying processing 11 via the gas discharge pipe 31 as shown in FIG. 5B, liquid is not detected by the fluid flow meter 34. Therefore, it is possible to detect the completion of the discharge of the excess IPA 44 on the substrate 1 by detecting, with the fluid flow meter 34, presence or absence of liquid in the gas discharged via the gas discharge pipe 31.

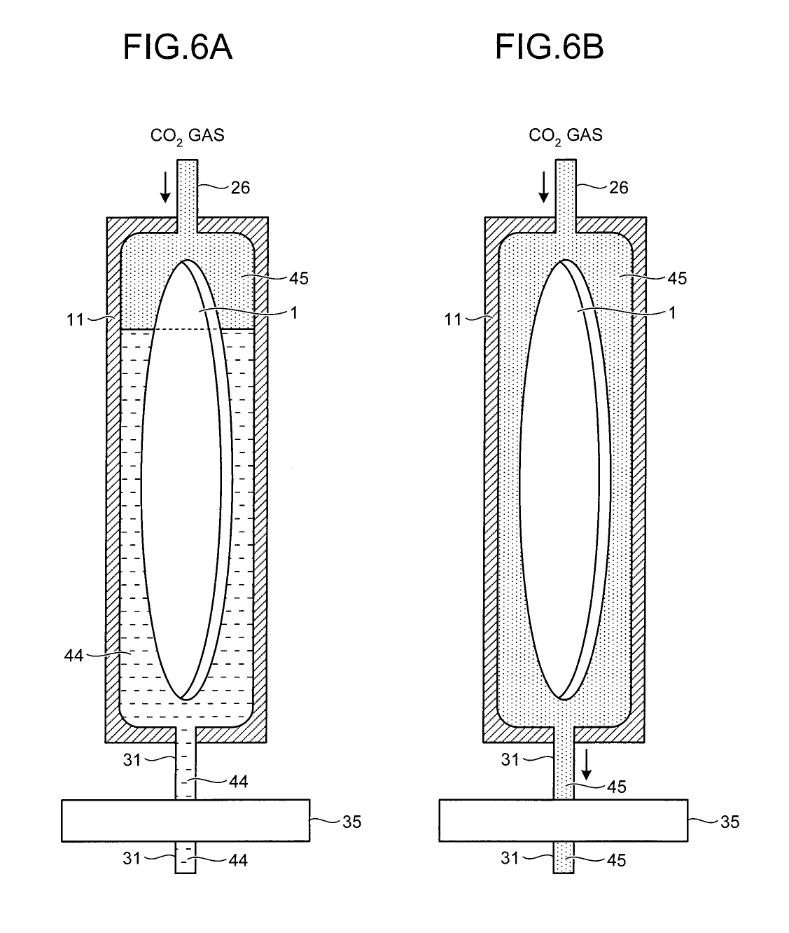

FIGS. 6A and 6B are schematic diagrams for explaining the processing for detecting the completion of discharge of the IPA 44 using the gas densitometer 35. The start of the processing for discharging the excess IPA 44 is shown in FIG. 6A. The completion of the processing for discharging the excess IPA 44 on the substrate 1 is shown in FIG. 6B. At the start of the processing for discharging the IPA 44 on the substrate 1, because the carbon dioxide gas 45 is not included in the gas discharge pipe 31 as shown in FIG. 6A, the carbon dioxide gas 45 is not detected by the gas densitometer 35 provided halfway in the gas discharge pipe 31.

On the other hand, when the discharge of the IPA 44 on the substrate 1 is completed, because the carbon dioxide gas 45 is included in the gas discharge pipe 31 as shown in FIG. 6B, the gas densitometer 35 provided halfway in the gas discharge pipe 31 operates and the carbon dioxide gas 45 is detected. Therefore, because the gas densitometer 35 detects the carbon dioxide gas 45, it is possible to detect the completion of the discharge of the excess IPA 44 on the substrate 1.

A method of detecting the completion of the discharge of the IPA 44 is not limited to this. Other methods can be used as long as the completion of the discharge of the IPA 44 can be detected.

When the completion of the discharge of the excess IPA 44 on the substrate 1 is not detected (“No” at step S50), the supercritical drying apparatus returns to step S40 and continues the processing for discharging the excess IPA 44. When the completion of the discharge of the excess IPA 44 on the substrate 1 is detected (“Yes” at step S50), the supercritical drying apparatus stops the discharge of the gas in the chamber for supercritical drying processing 11 by the gas discharging unit, raises temperature and pressure in the chamber for supercritical drying processing 11 to be equal to or higher than critical points, and performs supercritical drying (step S60 in FIG. 3E).

Specifically, the supercritical drying apparatus raises the temperature in the chamber for supercritical drying processing 11 to be equal to or higher than 31.1° C. using the pump unit 23 and the heating plate 12, raises the pressure in the chamber for supercritical drying processing 11 to be equal to or higher than 7.4 megapascals using the pump unit 23, and changes the carbon dioxide gas 45 in the chamber for supercritical drying processing 11 to supercritical carbon dioxide (SCCO₂) 46 as supercritical fluid. After changing the carbon dioxide gas 45 in the chamber for supercritical drying processing 11 to a supercritical state, the supercritical drying apparatus stops the supply of the carbon dioxide gas 45 to the chamber for supercritical drying processing 11 and holds the substrate 1 under a supercritical carbon dioxide state. Consequently, the IPA 44 is discharged (dissolved) into the supercritical carbon dioxide 46 from the surface of the substrate 1 and the spaces among the fine patterns 2. The IPA 44 remaining among the fine patterns 2 is displaced with the supercritical carbon dioxide 46.

After the spaces among the fine patterns 2 are completely filled with the supercritical carbon dioxide 46, the supercritical drying apparatus lowers the pressure in the chamber for supercritical drying processing 11 to the atmospheric pressure and vaporizes the supercritical carbon dioxide 46 to return the supercritical carbon dioxide 46 to the carbon dioxide gas 45 (step S70 in FIG. 3F). At this point, in the chamber for supercritical drying processing 11 including the spaces among the fine patterns 2, the supercritical carbon dioxide 46 in which the IPA 44 is dissolved vaporizes. After discharging the carbon dioxide gas 45 from the gas discharge pipe 31 and releasing the carbon dioxide gas 45 to the atmosphere, the supercritical drying apparatus takes out the substrate from the chamber for supercritical drying processing 11 (FIG. 3G). Consequently, a series of supercritical drying processing according to the first embodiment ends.

In the processing explained above, the excess IPA 44 present on the pattern forming surface of the substrate 1 in the processing is discharged from the chamber for supercritical drying processing 11 in advance before the supercritical drying. This is for the purpose of realizing sure supercritical drying and more quickly and more surely discharging the IPA 44 among the fine patterns when the carbon dioxide gas 45 in the chamber for supercritical drying processing 11 is changed to the supercritical state.

To surely perform the supercritical drying, it is necessary to surely dissolve the IPA 44, which is present in the chamber for supercritical drying processing 11, in the supercritical carbon dioxide 46 and discharge the IPA 44. However, when the IPA 44 in the chamber for supercritical drying processing 11 increases, time for holding the substrate 1 in the supercritical carbon dioxide 46 to surely dissolve the IPA 44 in the supercritical carbon dioxide 46 (supercritical time) is extended and supercritical drying time is extended.

In Table 1, a pattern survival rate of the fine patterns 2 after drying obtained when the supercritical drying of the substrate 1 was carried out under the same conditions except that the holding time in the supercritical carbon dioxide 46 (the supercritical time) was changed to one minute, five minutes, and 41 minutes. The supercritical drying was performed by using the supercritical drying apparatus according to the first embodiment. The survival rate is a ratio of the fine patters 2 that maintain a normal state without causing pattern collapse after the supercritical drying to all the fine patterns 2.

TABLE 1

| | | |
|---|---|---|
| In chamber | Supercritical | Pattern survival |

| Pressure | Temperature | time | rate |
|---|---|---|---|
| 8 MPa | 40° c. | 1 min | 86.31% |
| 8 MPa | 40° c. | 5 min | 99.00% |
| 8 MPa | 40° c. | 41 min | 99.20% |

It is seen from Table 1 that the survival rate of the fine patterns 2 after drying is improved by extending the supercritical time. It is seen from this that pattern collapse decreases when the IPA 44 on the substrate 1 is sufficiently displaced with the supercritical carbon oxide 46. Therefore, to reduce the supercritical time and efficiently perform the supercritical drying while improving the survival rate of the fine patterns 2, it is necessary to reduce an amount of the IPA 44 held on the substrate 1 and reduce an amount of the IPA 44 brought into the supercritical carbon dioxide state.

Therefore, in the supercritical drying method according to the first embodiment, before the IPA 44 is held in the supercritical carbon dioxide state, the excess IPA 44 present on the pattern forming surface of the substrate 1 is pressurized and discharged from the chamber for supercritical drying processing 11 in the liquid state by the carbon dioxide gas 45 in advance. Consequently, the amount of the IPA 44 brought into the supercritical carbon dioxide state decreases. Therefore, it is possible to surely perform displacement of the IPA 44 while reducing the holding time in the supercritical carbon dioxide state and surely and efficiently perform the supercritical drying.

Further, before the IPA 44 is held in the supercritical carbon dioxide state, the excess IPA 44 adhering to the rear side of the substrate 1 is pressurized and discharged from the chamber for supercritical drying processing 11 in the liquid state by the carbon dioxide gas 45 in advance, whereby the amount of the IPA 44 brought into the supercritical carbon dioxide carbon state further decreases. Therefore, it is possible to surely perform displacement of the IPA 44 while further reducing the holding time in the supercritical carbon dioxide state and more surely and more efficiently perform the supercritical drying.

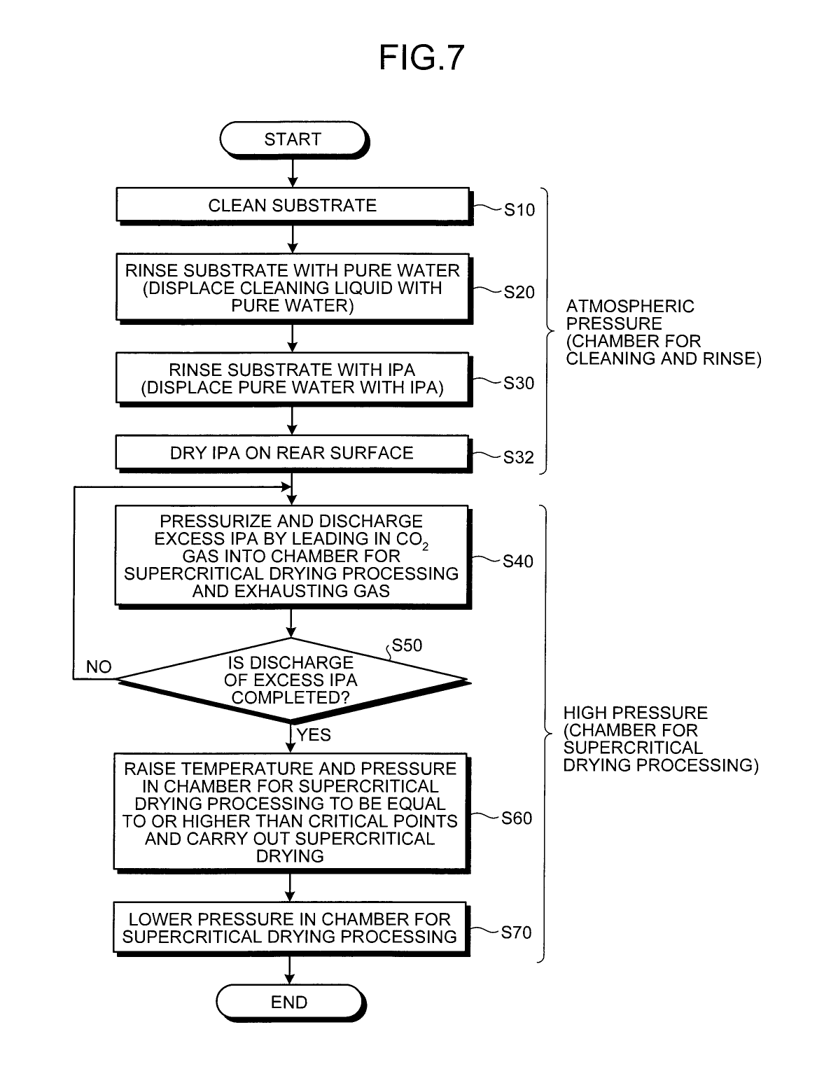

As a method of removing the excess IPA 44 adhering to the rear side of the substrate 1 in advance before holding the IPA 44 in the supercritical carbon dioxide state, a step of performing drying of the rear surface of the substrate 1 can be provided between steps S30 and S40 and before loading the substrate 1 into the chamber for supercritical drying processing 11. FIG. 7 is a flowchart for explaining another example of the supercritical drying method according to the first embodiment. In the flowchart of FIG. 7, a step of performing IPA drying on the rear surface (step S32) is added to the flowchart of FIG. 2. As a method of removing the excess IPA 44 adhering to the rear side of the substrate 1 at step S32 in advance before holding the IPA 44 in the supercritical carbon dioxide state, for example, at least one of nitrogen (N₂) gas blow, air cutter, and low-speed spin can be used.

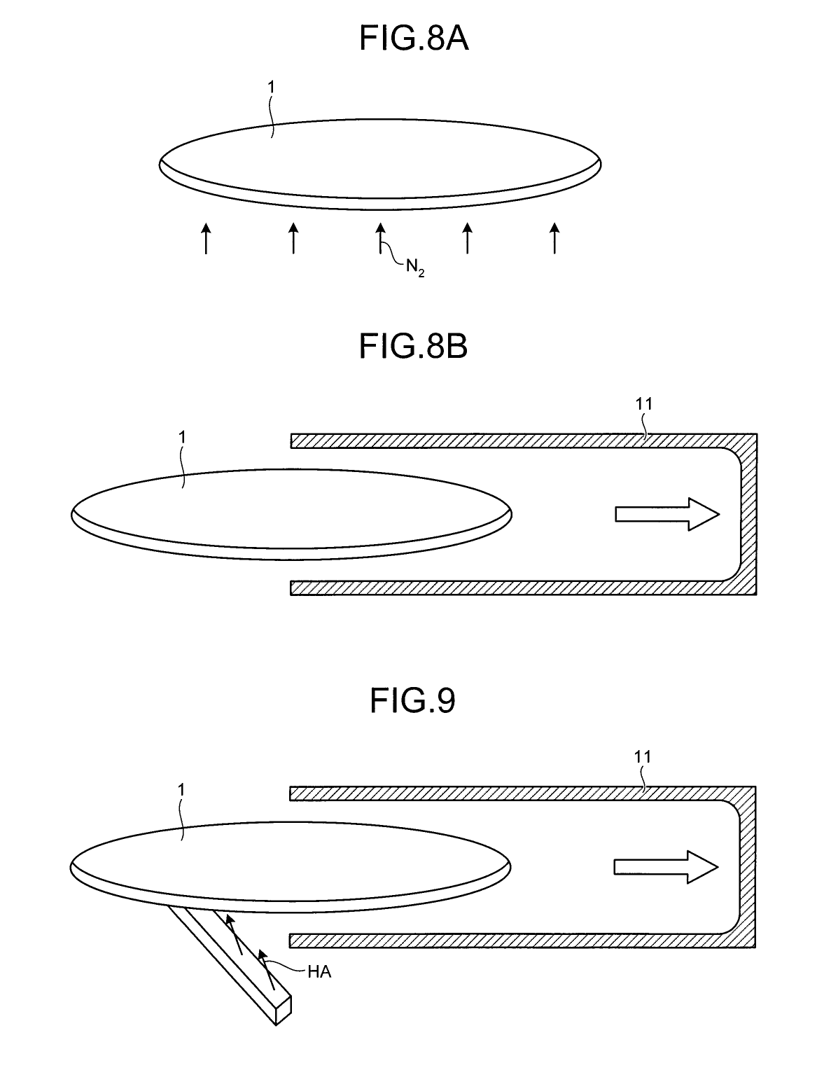

FIGS. 8A and 8B are schematic diagrams for explaining drying of the rear surface of the substrate 1 by the nitrogen (N₂) gas blow. In the drying of the rear surface of the substrate 1 by the nitrogen (N₂) gas blow, as shown in FIG. 8A, after step S30, nitrogen (N₂) gas is radiated on the rear side of the substrate 1 to carry out drying in the chamber for cleaning and rinse or in the state taken out from the chamber for cleaning and rinse. After the drying of the rear side of the substrate 1, as shown in FIG. 8B, the substrate 1 is loaded into the chamber for supercritical drying processing 11 and step S40 is carried out. As gas used for gas blow, besides the nitrogen (N₂) gas, high pressure air (HA) used in a semiconductor process, high-temperature gas, and the like can also be used.

FIG. 9 is a schematic diagram for explaining the drying of the rear surface of the substrate 1 by the air cutter. In the drying of the rear surface of the substrate 1 by the air cutter, when the substrate 1 taken out from the chamber for cleaning and rinse after step S30 is loaded into the chamber for supercritical drying processing 11 as shown in FIG. 9, the rear side of the substrate 1 is simultaneously dried by the air cutter. As gas used for the air cutter, for example, nitrogen gas (N₂) gas, high pressure air (HA) used in a semiconductor process, and high-temperature gas can be used.

When the excess IPA 44 on the substrate 1 is removed at step S40 explained above, in this embodiment, carbon dioxide gas having higher solubility of IPA than liquefied carbon dioxide and supercritical carbon dioxide is used. Among kinds of carbon dioxide gas, in particular, carbon dioxide gas under condition that temperature is equal to or higher than 31.1° C. and pressure is lower than 7.3 megapascals is used to perform the pressurization and the removal of the excess IPA 44 on the substrate 1. In the carbon dioxide gas atmosphere under such conditions, the IPA 44 keeps the liquid state.

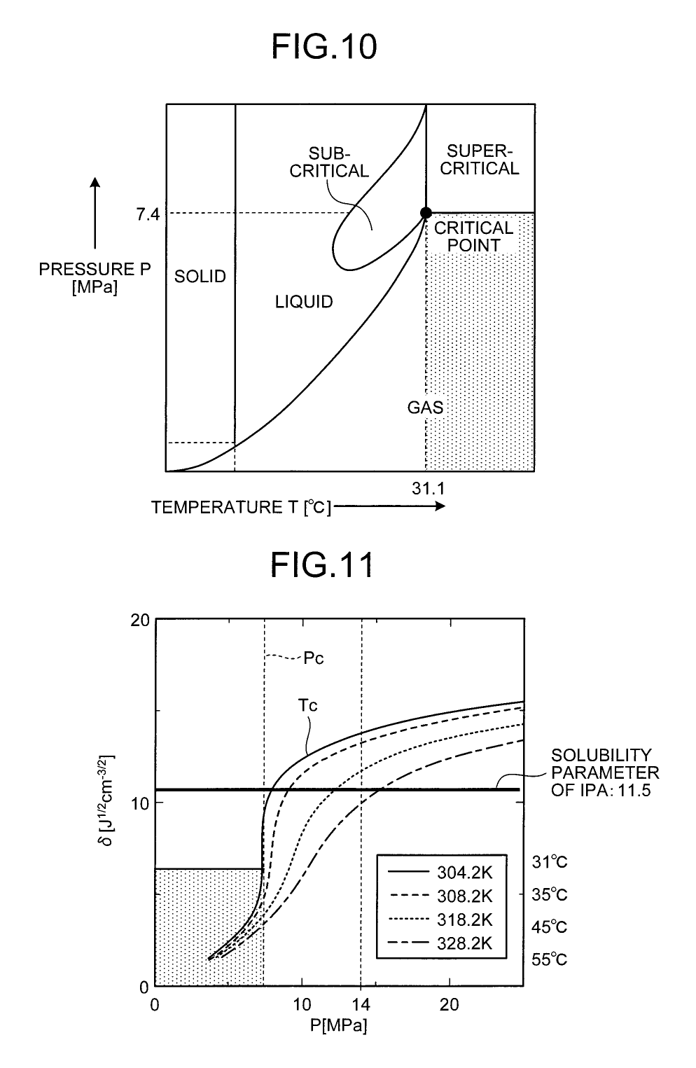

FIG. 10 is a diagram of a state of carbon dioxide. In this embodiment, in the kinds of carbon dioxide gas, in particular, carbon dioxide gas under condition that temperature is equal to or higher than 31.1° C. and pressure is lower than 7.4 megapascals is used. In FIG. 10, a hatched area corresponds to the carbon dioxide gas. The temperature is specified to be equal to or higher than 31.1° C. because it is likely that the carbon dioxide gas is liquefied when the temperature is lower than 31.1° C. An upper limit of the temperature is temperature at which saturated vapor pressure of IPA is lower than 7.4 megapascals. A lower limit of the pressure is the atmospheric pressure.

As a reason of using the carbon dioxide gas for the removal of the excess IPA 44 on the substrate 1 in this embodiment, there is a solubility parameter (an SP value) δ that is an index indicating a dissolving ability. A solubility parameter is a standard of solubility of a two-component solution. FIG. 11 is a characteristic chart of a relation between IPA and solubility parameters of carbon dioxide (cited from the doctoral thesis of Yasuihiko Yagi, Tohoku University (1993)).

In FIG. 11, plot curves indicate the solubility parameters of the carbon dioxide. A plot straight line on which the solubility parameter δ is 11.5 indicates a solubility parameter of the IPA. The abscissa indicates pressure, the left ordinate indicates the solubility parameter, and the right ordinate indicates temperature. As the solubility parameter of the carbon dioxide and the solubility parameter of the IPA are closer, solubility of the IPA in the carbon dioxide is higher. As the plot curve of the solubility parameter of the carbon dioxide is closer the plot straight line of the solubility parameter of the IPA, solubility of the IPA in the carbon dioxide is higher.

It is seen from FIG. 11 that, when attention is paid to a section of pressure lower than 7.4 megapascals, the solubility parameter of the carbon dioxide is lower as the temperature is higher. The solubility parameters indicate that the IPA is more easily dissolved as a difference between two components is smaller. This indicates that the IPA is less easily dissolved in the carbon dioxide as the temperature is higher.

On the other hand, the solubility parameters indicate that the IPA is more easily dissolved as a difference between two components is smaller. Therefore, it is seen from FIG. 11 that, in the case of liquefied carbon oxide (lower than 31.1° C.), compared with carbon oxide having temperature equal to or higher than 31.4° C., the solubility parameter is close to the solubility parameter of the IPA and the IPA is easily dissolved in the carbon dioxide.

The solubility parameters indicate that the IPA is more easily dissolved as a difference between two components is smaller. Therefore, it is seen from FIG. 11 that, in the case of supercritical carbon dioxide state, in particular, when the pressure of the carbon dioxide is about critical pressure Pc (7.4 megapascals), which is pressure used in normal supercritical drying, to 14 megapascals, compared with the carbon dioxide having pressure smaller than 7.4 megapascals, the solubility parameter is close to the solubility parameter of the IPA and the IPA is easily dissolved in the carbon dioxide.

Consequently, in discharging the supercritical displacement solvent using the liquefied carbon dioxide or the supercritical carbon dioxide, dissolution of the IPA in the carbon dioxide is larger than that in the gas (the carbon dioxide gas). When the dissolution of the IPA in the carbon dioxide is large, discharge of the liquefied carbon dioxide or the supercritical carbon dioxide in which the IPA is dissolved takes time and processing time is extended.

Therefore, in this embodiment, the carbon dioxide gas having solubility of the IPA lower than that of the liquefied carbon dioxide or the supercritical carbon dioxide is used for removal of the excess IPA 44 on the substrate 1. Before the pressure in the chamber for supercritical drying processing 11 reaches supercritical condition pressure, the temperature in the chamber for supercritical drying processing 11, into which the carbon dioxide gas is led in, is kept equal to or higher than supercritical temperature. Under that condition, the liquid IPA 44, which is an excess supercritical displacement solvent not involved in prevention of collapse of the fine patterns 2 formed on the surface of the substrate 1, is pressurized and discharged from the chamber for supercritical drying processing 11 while the liquid state is kept. This makes it possible to efficiently perform the removal of the excess IPA 44 on the substrate 1 in a short time before the IPA 44 is held in the supercritical carbon dioxide state. It can be understood from FIG. 11 that the temperature (of the carbon dioxide gas) in the chamber for supercritical drying processing 11 during the discharge of the excess IPA 44 is desirably equal to or higher than 31.1 degrees and more desirably in a higher temperature state.

After the completion of the discharge of the excess IPA 44, the substrate 1 is held under the supercritical carbon dioxide. This makes it possible to effectively dissolve only the IPA 44 contributing to the prevention of collapse of the fine patterns 2 formed on the surface of the substrate 1 in the supercritical carbon dioxide 46.

According to the first embodiment, the excess IPA 44 present on the pattern forming surface of the substrate 1 is pressurized and discharged from the chamber for supercritical drying processing 11 in the liquid state by the carbon dioxide gas 45 in advance before the IPA 44 is held in the supercritical carbon dioxide state. Consequently, because an amount of the IPA 44 brought into the supercritical carbon dioxide state decreases, it is possible to surely perform displacement of the IPA 44 while reducing the holding time in the supercritical carbon dioxide state and surely and efficiently perform the supercritical drying.

According to the first embodiment, because the carbon dioxide gas is used for removal of the excess IPA 44 on the substrate 1, it is possible to efficiently perform the removal of the excess IPA 44 on the substrate 1 in a short time before the IPA 44 is held in the supercritical carbon dioxide state.

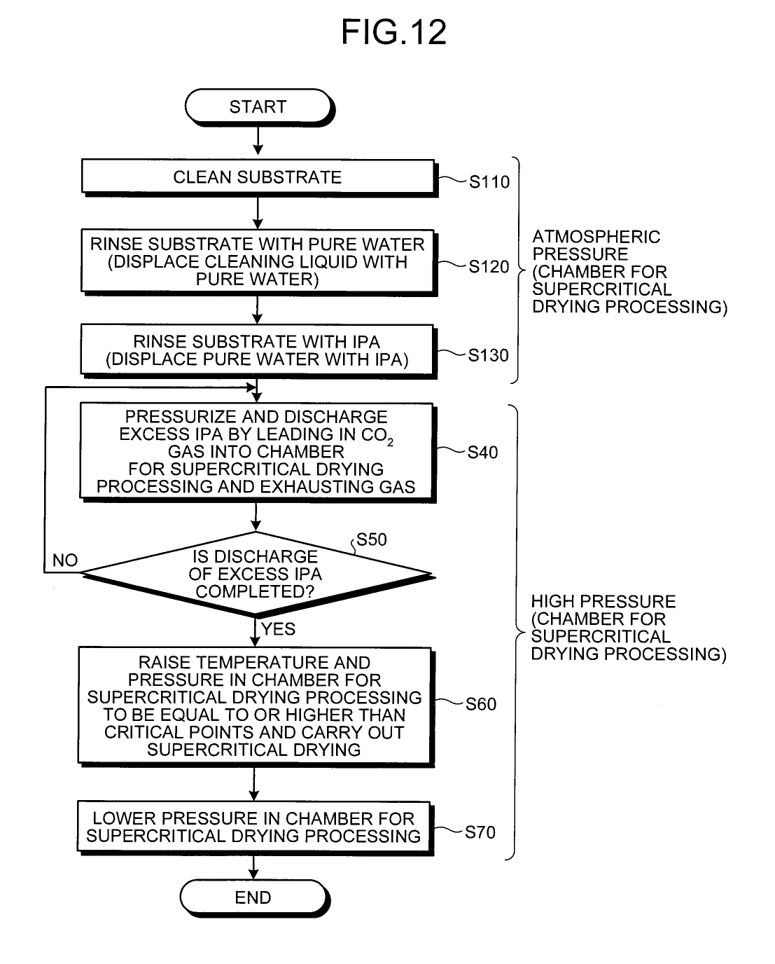

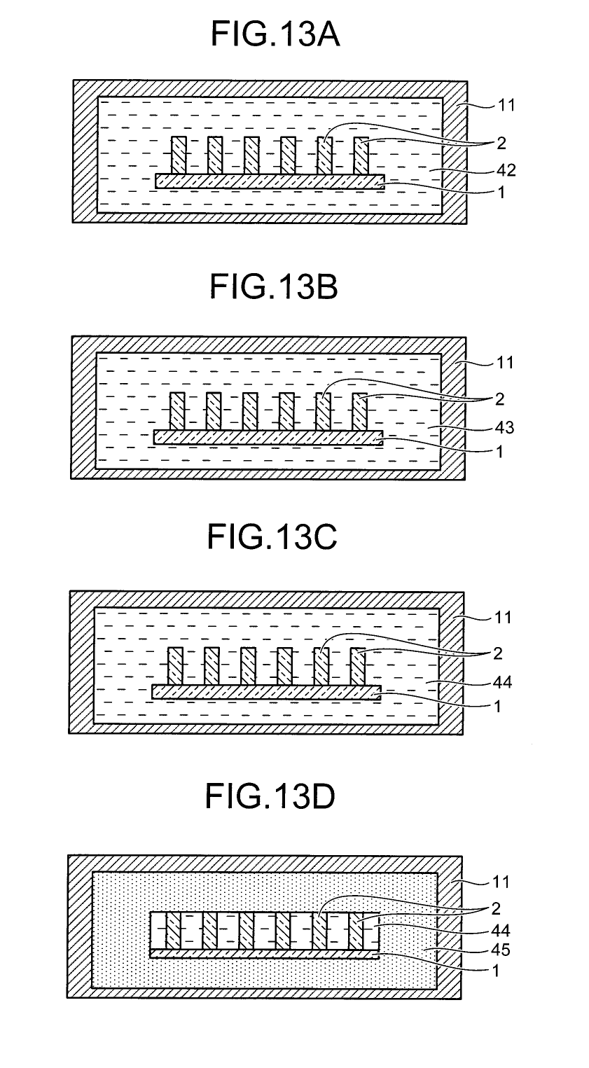

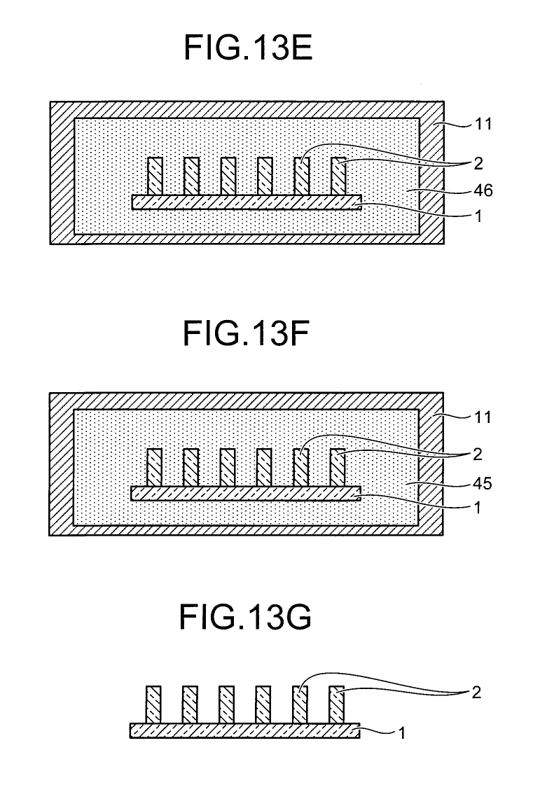

FIG. 12 is a flowchart for explaining an example of a supercritical drying method according to a second embodiment. FIGS. 13A to 13G are schematic diagrams for explaining the example of the supercritical drying method according to the second embodiment. In FIG. 12 and FIGS. 13A to 13G, members and processing same as those shown in FIG. 2 and FIGS. 3A to 3G in the first embodiment are denoted by the same reference numerals and signs and detailed explanation of the members and the processing is omitted. The supercritical drying method according to the second embodiment is carried out using the supercritical drying apparatus according to the first embodiment.

In the supercritical drying method according to the second embodiment shown in FIG. 12 and FIGS. 13A to 13G, basically, processing same as that of the supercritical drying method for a substrate according to the first embodiment shown in FIG. 2 and FIGS. 3A to 3G is carried out. Steps S110 to S130 respectively correspond to steps S10 to S30 in the supercritical drying method for a substrate according to the first embodiment.

The supercritical drying method according to the second embodiment is different from the supercritical drying method for a substrate according to the first embodiment shown in FIG. 2 and FIGS. 3A to 3G in that steps S10 to S30 in the supercritical drying method for a substrate according to the first embodiment are carried out under the atmospheric pressure in the chamber for supercritical drying processing (the second chamber) that is the chamber for supercritical drying processing 11 (FIGS. 13A to 13C). Processing at steps S40 to S70 after the processing (FIGS. 13D to 13G) is the same as that of the supercritical drying method for a substrate according to the first embodiment. Therefore, the supercritical drying method according to the second embodiment can be performed in the same manner as the supercritical drying method for a substrate according to the first embodiment except that steps S110 to S130 are carried out in the chamber for supercritical drying processing 11.

For example, as in the first embodiment, a step of performing IPA drying of the rear surface of the substrate 1 by nitrogen (N₂) gas blow, air cutter, low-speed spin, or the like can be provided between steps S130 and S40. This step can be carried out in the chamber for supercritical drying processing 11 or can be carried out by unloading the substrate 1 to the outside of the chamber for supercritical drying processing 11. When the step is carried out in the chamber for supercritical drying processing 11, a structure that can carry out the drying step is provided in the chamber for supercritical drying processing 11.

According to the second embodiment, as in the first embodiment, the excess IPA 44 present on the pattern forming surface of the substrate 1 is pressurized and discharged from the chamber for supercritical drying processing 11 in the liquid state by the carbon dioxide gas 45 in advance. Consequently, because an amount of the IPA 44 brought into the supercritical carbon dioxide state decreases, it is possible to surely perform displacement of the IPA 44 while reducing the holding time in the supercritical carbon dioxide state and surely and efficiently perform the supercritical drying.

According to the second embodiment, as in the first embodiment, because the carbon dioxide gas is used for removal of the excess IPA 44 on the substrate 1, it is possible to efficiently perform the removal of the excess IPA 44 on the substrate 1 in a short time before the IPA 44 is held in the supercritical carbon dioxide state.

According to the second embodiment, because the steps from the cleaning of the substrate 1 to the completion of the supercritical drying processing for the substrate 1 are performed in the same chamber for supercritical drying processing 11, processing such as conveyance of a substrate is unnecessary and it is possible to efficiently perform the cleaning of the substrate 1 and the drying processing for the substrate 1.

In the examples explained in the embodiments, one substrate 1 is processed. However, the embodiment can be applied to both single-wafer processing and batch processing.

In the explanation of the embodiments, the IPA is used as the second displacement liquid brought into the supercritical carbon dioxide state. However, the second displacement liquid is not limited to this. Other kinds of displacement liquid that can realize the supercritical drying can also be used.

In the embodiments, the supercritical drying of the semiconductor substrate is explained as the example. However, a type of a substrate is not limited to this. The supercritical drying method explained above can be widely applied to substrates that can be dried.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A supercritical drying method comprising:
cleaning, with cleaning liquid, a substrate having a plurality of adjacent patterns on one surface thereof;
after displacing the cleaning liquid with pure water, displacing the pure water with displacement liquid;
removing, under a condition that the displacement liquid among the patterns does not vaporize, the displacement liquid not contributing to prevention of collapse of the patterns;
after removing the displacement, holding the substrate in supercritical fluid and displacing the displacement liquid among the patterns with the supercritical fluid; and
after displacing the displacement liquid among the patterns with the supercritical fluid, vaporizing the supercritical fluid adhering to the substrate.

2. The supercritical drying method according to claim 1, wherein the removing the displacement liquid includes removing the displacement liquid adhering to a surface of the substrate and not contributing to the prevention of collapse of the patterns.

3. The supercritical drying method according to claim 1, wherein the removing the displacement liquid includes removing the displacement liquid adhering to an inside of a supercritical drying processing tank.

4. The supercritical drying method according to claim 1, wherein, as a method of removing, in a liquid state, the displacement liquid not contributing to the prevention of collapse of the patterns on the substrate, any one or more of an air cutter, spin drying, and high-pressure drain are used.

5. The supercritical drying method according to claim 1, further comprising, in removing, in a liquid state, the displacement liquid not contributing to the prevention of collapse of the patterns on the substrate, sensing a removal state of the displacement liquid to detect completion time of the removal of the displacement liquid.

6. The supercritical drying method according to claim 5, wherein the displacement liquid is alcohols.

7. The supercritical drying method according to claim 6, wherein the displacement liquid is IPA.

8. The supercritical drying method according to claim 1, wherein the supercritical fluid is carbon dioxide.

9. A supercritical drying apparatus comprising:
a closable processing chamber in which a substrate to be processed is held;
a gas supplying unit for supplying gas for removing a displacement liquid and carbon dioxide gas to be supercritical fluid to the processing chamber;
a discharging unit that discharges the gas and liquid in the processing chamber;
a pressure control unit that controls pressure in the processing chamber to pressure for bringing the carbon dioxide into a supercritical state or higher pressure;
a temperature control unit that controls temperature in the processing chamber to temperature for bringing the carbon dioxide into the supercritical state or higher temperature; and
a discharge-state detecting unit that detects a discharge state of the liquid discharged from the processing chamber via the discharging unit.

10. The supercritical drying apparatus according to claim 9, wherein the gas for removing the displacement liquid is inert gas such as carbon dioxide or nitrogen or air.

11. The supercritical drying apparatus according to claim 9, wherein the discharge-state detecting unit is a capacitance sensor, a fluid flow meter, or a gas densitometer.
